(19) United States
(12) Patent Application Publication
(10) Pub. No.: US 2013/0179421 A1
(43) Pub. Date: Jul. 11, 2013

(54) System and Method for Collecting URL Information Using Retrieval Service of Social Network Service

(71) Applicants: Hyun Cheol Jeong, Seoul (KR); Seung Goo Ji, Seoul (KR); Tai Jin Lee, Seoul (KR); Jong Il Jeong, Seoul (KR); Hong Koo Kang, Seoul (KR); Byung Ik Kim, Seoul (KR)

(72) Inventors: Hyun Cheol Jeong, Seoul (KR); Seung Goo Ji, Seoul (KR); Tai Jin Lee, Seoul (KR); Jong Il Jeong, Seoul (KR); Hong Koo Kang, Seoul (KR); Byung Ik Kim, Seoul (KR)

(21) Appl. No.: 13/676,599

(22) Filed: Nov. 14, 2012

(30) Foreign Application Priority Data
Dec. 9, 2011 (KR) 10-2011-0132122

(51) Int. Cl. G06F 17/30

(52) U.S. Cl. CPC G06F 17/30882
USPC 707/706

(57) ABSTRACT

A system and method for collecting a URL using a retrieval service of an SNS capable of accurately and effectively extracting and collecting information including a malicious code among information exchanged in an SNS are provided. URL information included in post (a bulletin script, a message, a note, or the like) exchanged in an SNS based on real-time search word information is extracted and collected to be utilized for collecting a malicious code in the SNS, whereby generation of a malicious code in the SNS can be prevented in advance, and thus, damage to users due to infection of a malicious code can be significantly reduced. In addition, the URL information can be effectively collected through crawling.

### CROSS-REFERENCE TO RELATED PATENT APPLICATIONS

This patent application claims priority to Korean Patent Application No. 10-2011-0132122, filed Dec. 9, 2011, the entire teachings and disclosure of which are incorporated herein by reference thereto.

### FIELD OF THE INVENTION

The present invention relates to a system and method for collecting a uniform resource locator (URL) using a retrieval service of a social networking service (SNS) and, more particularly, to a system and method for collecting a URL using a retrieval service of an SNS capable of accurately and effectively extracting and collecting information including a malicious code among information exchanged in an SNS.

### BACKGROUND AND DESCRIPTION OF THE RELATED ART

Recently, many people use a social networking service (SNS) to share interests or activities with close acquaintances. In particular, mobile devices such as smart phones, tablet PCs, and the like, have become rapidly prevalent to allow users to bring their word or readily hear of acquaintances, irrespective of places. Service types of SNS include foreign-based SNS such as Twitter, Facebook, and the like, and domestic SNS such as Cyworld, me2day, and the like.

However, SNS allowing a user to exchange information with acquaintances in real time also has disadvantages as well as advantages as mentioned above. The biggest problem is inspection of a malicious code due to a connection to a malicious Website. Other problems such as a leakage of personal information, dissemination of false information, and impersonation of a celebrity, and the like, also exist.

Among them, existing malicious code dissemination usually features dissemination of malicious codes through hacking of a Web page. Dissemination of malicious codes target many and unspecified users. An attempter of a malicious code should hack a normal Web page and insert a malicious code flow URL. Or, a process of inducing a false Web page similar to an actual Web page is required.

Thus, the existing malicious code dissemination method requires multiple preparation processes, and a failure of one of the processes results in a failure of dissemination of a malicious code.

Currently, in case of disseminating a malicious code through an SNS, since a user who creates an SNS post (or an SNS notice) and a visitor are trusted, a malicious code can be more definitely disseminated. Also, in order to disseminate a malicious code, inducement of users through website hacking is not necessary, so an effective malicious code dissemination path is generated.

Thus, in addition to the features, a malicious code is disseminated within a shorter time than in the past, by using the advantages of the SNS exchanging information in real time. Thus, a more stable Internet environment is required to be established by checking dissemination of a malicious code in the SNS which sees an increasing number of users, but a method that may be able to quickly cope with it has yet to be presented.

### SUMMARY OF THE INVENTION

An aspect of the present invention provides a system and method for collecting uniform resource locator (URL) information using a retrieval service of a social networking service (SNS) capable of locating a URL for a malicious code disseminated from SNS post such as a bulletin board message (i.e., a bulletin script or an online article), a message, or a note, based on real-time search word information provided from a search site and utilizing the same.

Features of the present invention to achieve the object of the present invention and perform characteristic functions of the present invention as mentioned above are as follows.

According to an aspect of the present invention, there is provided a system for collecting a uniform resource locator (URL) using a retrieval service of a social networking service (SNS), including: a search word collecting module configured to periodically collect ranked real-time search word information provided through a search site; a URL collecting module configured to extract and collect URL information of post exchanged in an SNS site based on the real-time search word information; and a registration management module configured to check whether or not the collected real-time search word information and the collected URL information are repeated within a pre-set time, and register the real-time search word information and the URL information when they are not repeated.

The URL collecting system may further include: a history information collecting module configured to collect history information in relation to the real-time search word information and URL information, the history information including details of an initial collecting time, a search word collecting path, the number of repeated collecting, and a repeated collecting time.

The search word collecting module and the URL collecting module may collect the real-time search word information and the URL information by using an open API provided from the search site and the SNS site, respectively.

The URL collecting module may extract the URL information by crawling a post URL of the post.

The system may further include: an original URL collecting module configured to access an original site which has generated a shortened URL and obtain original URL information from an original site, when the URL information is a shortened URL.

According to an aspect of the present invention, there is provided a method for collecting a uniform resource locator (URL) using a retrieval service of a social networking service (SNS), including: (a) executing an interworking process between a URL collecting system and a search site; (b) determining whether or not there is a new search word list as a real-time ranking provided from the search site, after (a) is executed; (c) when it is determined that there is a new search word list, receiving the new search word list from the search site; (d) executing an interworking process between the URL collecting system and an SNS site; (e) determining whether or not certain real-time search word information on the received new search word list is included in post in the SNS site, after (d) is executed; (f) when it is determined that the real-time search word information is included in the post, extracting and collecting URL information from the post; and (g) registering the collected new search word list and URL information.

The method may further include: (h) determining whether or not a certain search word on the received new search word list and a previously stored search word are identical, and removing a repeated word when the certain search word and the stored search word are identical, between (c) and (d).

The method may further include: (i) determining whether or not the collected URL information and the previously stored URL information are identical and removing repeated URL information when the collected URL information and the stored URL information are identical, between (f) and (g).

In (a) and (d), the search site and the SNS site may be accessed by using an open API.

In (f), the URL information may be extracted by crawling the post URL of the post.

The method may further include: (j) accessing an original site which has generated the shortened URL and obtaining original URL information from an original site, when the URL information is a shortened URL.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a system 100 for collecting a URL using a retrieval service of a social networking service (SNS) social networking service (SNS) according to a first embodiment of the present invention.

FIGS. 2 and 3 are views illustrating real-time search word information in the form of a list according to the first embodiment of the present invention.

FIG. 4 is a flow chart illustrating a method for collecting a uniform resource locator (URL) (S100) using a retrieval service of an SNS according to a second embodiment of the present invention.

FIG. 5 is a diagram illustrating a process of collecting real-time search word or URL information in the method for collecting a URL (S100) according to the second embodiment of the present invention.

FIG. 6 is a diagram illustrating a process of processing a shortened URL according to the second embodiment of the present invention.

### DETAILED DESCRIPTION OF THE INVENTION

Hereinafter, embodiments will be described in detail with reference to the accompanying drawings such that they can be easily practiced by those skilled in the art to which the present invention pertains. However, the present invention may be implemented in various forms and not limited to the embodiments disclosed hereinafter. Also, similar reference numerals are used for the similar parts throughout the specification.

### First Embodiment

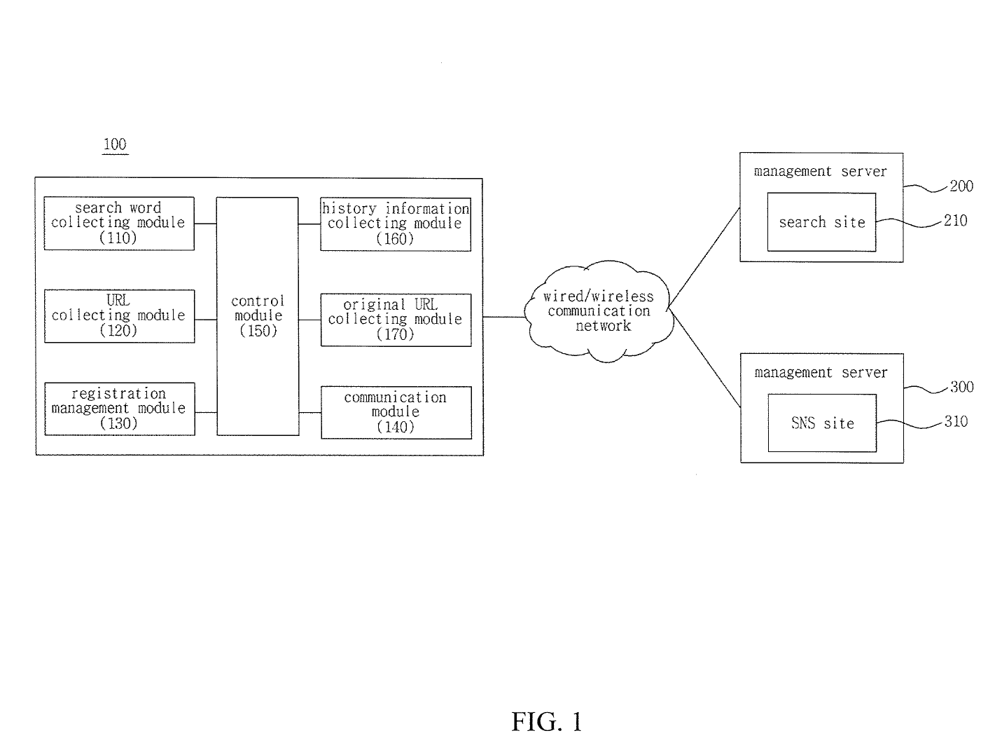

FIG. 1 is a system 100 for collecting a URL (or a URL collecting system) using a retrieval service of a social networking service (SNS) social networking service (SNS) according to a first embodiment of the present invention.

Referring to FIG. 1, the URL collecting system 100 using a retrieval service of an SNS according to a first embodiment of the present invention is configured to include a search word collecting module 110, a URL collecting module 120, a registration management module 130, a communication module 140, and a control module 150.

First, the search word collecting module 110 according to the first embodiment of the present invention serves to access a search site and collect real time search word information provided from a search site 210, periodically, e.g., by the week.

Here, the collected real-time search word information refers to real-time information posted according to the ranking of real-time search word information provided from a search site 210 (or a portal search site) such as ‘naver’, ‘daum’, or the like, which mainly includes content (e.g., in the form of words or phrases) of social issues.

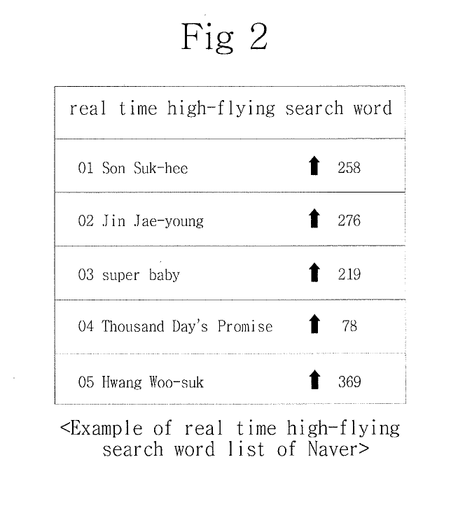

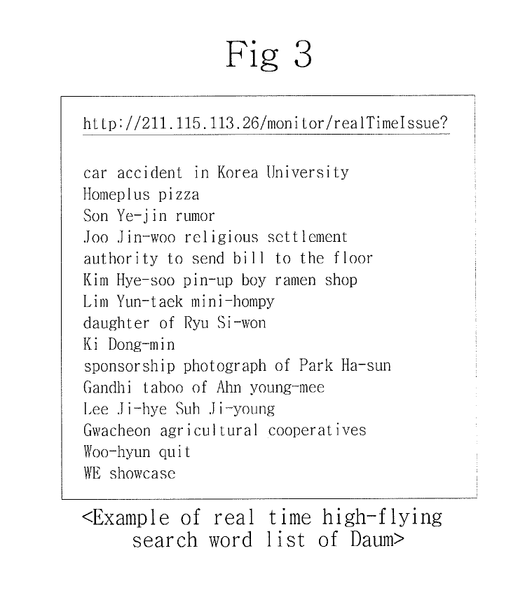

For example, the real-time search word information provided from the search sites ‘daum’ and ‘naver’ may have a list format as illustrated in FIGS. 2 and 3, and includes words or phrases which are at social issues or represent a high level of interest (ranking) to users. In case that the real-time search word information is categorized into, for example, café, blog, bulletin board, people, poet, drama, broadcast, movie, and the like, real-time search word information may be collected by category.

Here, in order to collect real-time search word information of the search site 210, the search word collecting module 110 uses an open API as illustrated in Table 1 shown below. Namely, the open API provided from the search site 210 is generally provided for the purpose of a developer, but in the present embodiment, the open API may be used for the purpose of obtaining URL information of an SNS as described hereinafter.

TABLE 1

| | Naver | Daum |
|---|---|---|
| Interworking | HTTP (Get type) | |
| protocol | | |
| Request | http://cpenapi.naver.com/ | http://211.115.113.26/ |
| URL | search?key=[APIKey]&query= | monitor/realTimeIssue? |
| | [query]&target=tank | |
| | http://openapi.naver.com/ | |
| | search?key=[APIKey]&query= | |
| | [query]&tatget=ranktheme | |
| Collecting | Web blog, newspaper, movie, | website |
| range | people, broadcast, etc. | |
| Transmission | Query—real-time search word | None |
| parameter | output | |
| | [café, blog, newspaper, etc.] | |

### Example of Real-Time Search Word Collecting API

Namely, when the open API provided from the search site 210 is used, up to a position of the real-time search word information posted in the search site 210 can be accessed and the search word collecting module 110 can easily obtain the real-time search word information.

The URL collecting module 120 serves to extract and collect all the URL information of the post exchanged within an SNS site 310 based on the real-time search word information collected by the search word collecting module 110.

Here, the post, content exchanged in the SNS site 310, refers to a medium such as a bulletin board message (i.e., a bulletin script or an online article), a message, or a note. Post such as a bulletin script includes URL information indicating a source of information thereof recorded therein all the time. Similarly, post such as a message includes URL information indicating a source of a spam mail disguised as a message of an SNS account manager or a friend recorded therein.

Thus, the URL collecting module 120 according to an embodiment of the present invention may directly extract and collect the URL information included in post such as a bulletin script, a message, a note, or the like, including the collected real-time search word information. In detail, like the access to real-time search word information using the open API as mentioned above, the URL collecting module 120 also checks post by using the open API provided from the SNS site 310. An example of the open API for checking a bulletin script provided from the SNS site 310 may be represented as shown in Table 2 below.

TABLE 2

| | Twitter | Me2day | Facebook | Cyworld |
|---|---|---|---|---|
| Interworking | HTTP (Get type) | HTTP (Get type) | HTTP (Get type) | HTTP (Get type) |
| protocol | | | | |
| Requested | http://searchtwitter.com/ | http://mw2day.net/searchxml?query= | http://www.facebook.com/ | http://blogcyworld.com/section/ |
| URL | searchatom?q=KEYWORD | [KEYWORD]&search_at=all | searchphp?q= | search/?q=KEYWORD&category=bbs |
| | | | KEYWORD?type=eposts | |
| Transmission | q-keyword (English | Query-keyword | w-search | Search_type-search |
| parameter | or URL encoding) | (English o URL | type[social] | target page |
| | | encoding) | m-web | bbs[bulletin script] |
| | | | q-site: pertinent | q-keyword (English |
| | | | search target site | or URL encoding) |
| | | | KEYWORD | category-bbs[Bulletin |
| | | | (English or URL | script] |
| | | | encoding) | q-keyword (English |
| | | | q-keyword (English | or URL encoding) |
| | | | or URL encoding) | |
| | | | type-search type | |
| | | | [bulletin script] | |
| Reference | http://dev.naver.com/ | http://www.google.co.kr/cse | http://www.bing.com | http://www. [symbol] com |
| page | openapi/apis/me2day/ | | | |

When post (e.g., a bulletin script, a message, a note, or the like) is checked by using such an open API, a post URL can be known. Upon checking the post URL, the URL collecting module 120 according to an embodiment of the present invention extracts URL information from the post through the post URL.

The extracted URL information may have a URL list form. As a result, the URL information may be changed into a URL list form through a crawling process.

The registration management module 130 according to an embodiment of the present invention receive the real-time search word information collected by the search word collecting module 110 and the URL information collected by the URL collecting module 120, and determines whether or not they are repeated within a pre-set time. When the search word information and the URL information are not repeated according to the determination result, the registration management module 130 registers the search word information and the URL information, and when the search word information and the URL information are repeated, the registration management module 130 deletes the newly collected search word information and URL information

The collected URL information included in post such as a bulletin script, a message, a note, and the like, of the SNS is utilized for locating a malicious code in the SNS.

The communication module 140 according to an embodiment of the present invention supports a communication interface between the URL collecting system 100 and a management server 200 providing a search site 210 and/or between the URL collecting system 100 and a management server 300 providing a SNS site 310, so the URL collecting system 100 and the management servers 200 and 300 providing the search site 210 and the SNS site 310, respectively, may transmit and receive data each other.

Thus, as noted therethrough, the real-time search word information and the URL information collected from the search site 210 and/or the SNS site 310 are substantially collected from the management servers 200 and 300 that manage the respective sites.

The control module 150 according to an embodiment of the present invention controls a data flow among the search word collecting module 110, the URL collecting module 120, the registration management module 130, and the communication module 140, to thus allow the search word collecting module 110, the URL collecting module 120, the registration management module 130, and the communication module 140 to process unique data thereof, respectively.

In this manner, the URL collecting system using a retrieval service of an SNS according to the first embodiment of the present invention can detect and interrupt a malicious code generated in an SNS in advance by collecting URL information of post (including a bulletin script, a message, a note, or the like) exchanged in the SNS based on real-time search word information, and thus, damage to users due to infection of a malicious code can be reduced.

Meanwhile, the URL collecting system using a retrieval service of an SNS according to the first embodiment of the present invention may further include a history information collecting module 160 and an original URL collecting module 170.

The history information collecting module 160 serves to collect history information in relation to real-time search word information and/or URL information, e.g., history information such as details of an initial collecting time, a search word collecting path, the number of repeated collecting, a repeated collecting time, and the like. To this end, the history information collecting module 160 are changed into an algorithm in association with the search word collecting module 110, the URL collecting module 120, the registration management module 130, or the like.

For example, when the history information collecting module 160 is associated with the search word collecting module 110, an event occurs each time the search word collecting module 110 collects corresponding real-time search word information, so the history information collecting module 160 can recognize an initial collecting time, a collecting path, and the like, with respect to the corresponding real time search word information.

Meanwhile, when URL information existing in post is a shortened URL, an original URL collecting module 170 according to an embodiment of the present invention accesses an original site that has generated the shortened URL, and obtains an original URL from the original site.

The obtained original URL is utilized to generate original URL information through a crawling process as mentioned above. In this manner, even when the URL information of the post is a shortened one, original URL information can be effectively collected. The original URL information is in line with the foregoing URL information.

### Second Embodiment

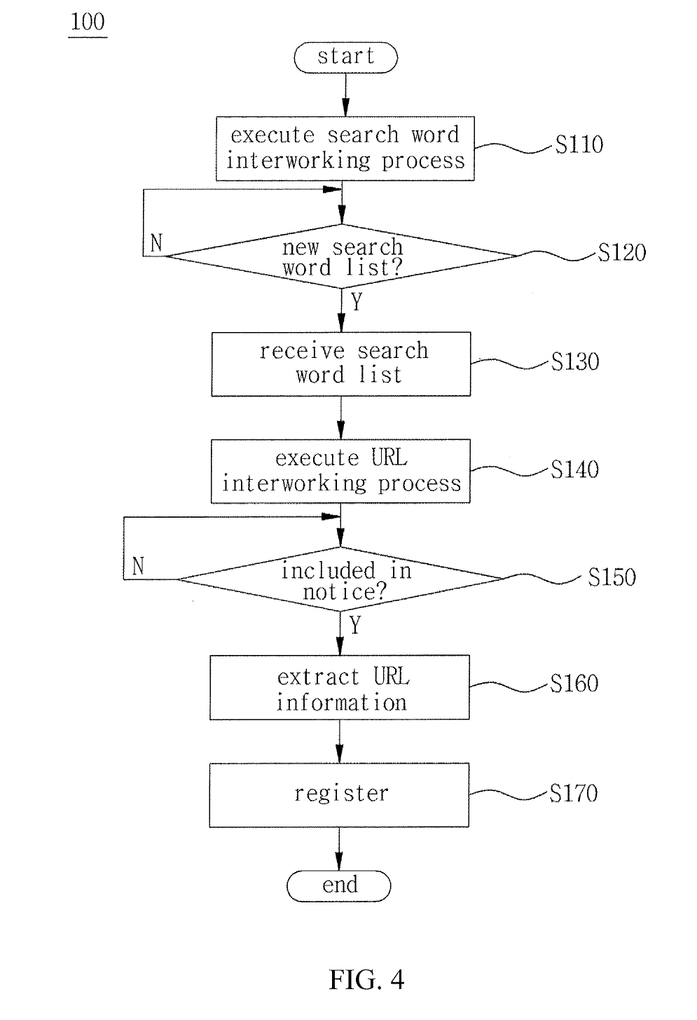

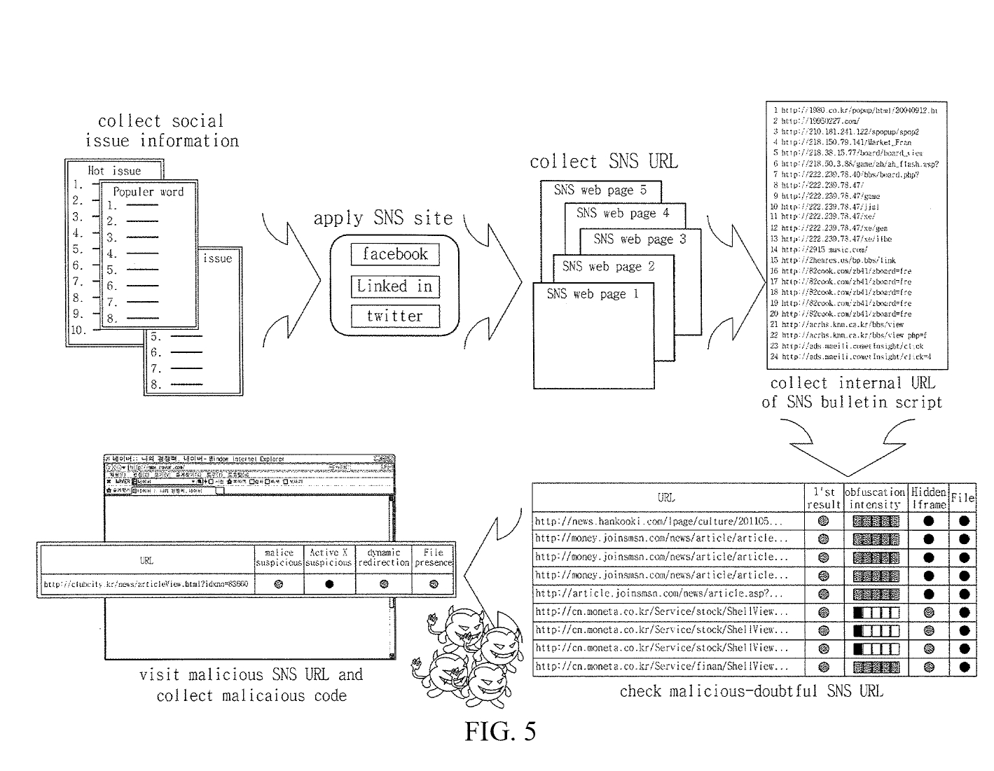

FIG. 4 is a flow chart illustrating a method for collecting a uniform resource locator (URL) (S100) using a retrieval service of an SNS according to a second embodiment of the present invention, and FIG. 5 is a diagram illustrating a process of collecting real-time search word or URL information in the method for collecting a URL (S100) according to the second embodiment of the present invention.

As illustrated, the method for collecting a URL (S100) using a retrieval service of an SNS according to the second embodiment of the present invention includes steps S110 to S170 in order to collect a URL hidden in post such as a bulletin script, a message, a note, and the like, infected by a malicious code generated in the SNS site 310.

First, in step S110, the URL collecting system 100 and the search site 210 perform an interworking process. When the interworking process is executed, it is determined whether or not there is a new search word list as a real-time ranking provided from the search site 210 in step S120.

When there is a new search word list, step S130 is performed, or otherwise, the process is returned to step S120 for retrying. The new search list mentioned herein refers to the real-time search word information described above with reference to FIGS. 1 to 3.

When it is determined that there is a new search word list according to the determination result in step S120, the new search word list is received from the search site 210 in step S130. In other words, real-time search word information as a social issue as shown in FIG. 5 is collected. Here, in order to check the new search word list, the new search word list is a result obtained by accessing by using the open API provided in the search site 210.

In step S140, the URL collecting system 100 and the SNS site 310 execute an interworking process. When the interworking process is executed, it is determined whether or not certain real-time search word information on the received new search word list is included in post of the SNS site 310 in step S150.

When certain real-time search word information is included in the post, step S160 is performed, or otherwise, the process is returned to step S150 for retrying. The post mentioned herein refers to a medium such as a bulletin script, a message, a note, or the like, exchanged in the SNS site 310.

In step S160, when it is determined that real-time search word information is included in the post, URL information of the post is extracted to be collected. In this case, in order to extract the URL information from the post, the post URL information may be first collected by using the open API provided from the SNS site 310 and the URL information of the post may be extracted to be collected by crawling the collected post URL information as shown in FIG. 5.

Here, the collected URL information of the post is the result obtained by crawling the post URL information, e.g., the result obtained by crawling URLs existing in the SNS bulletin script as shown in FIG. 5.

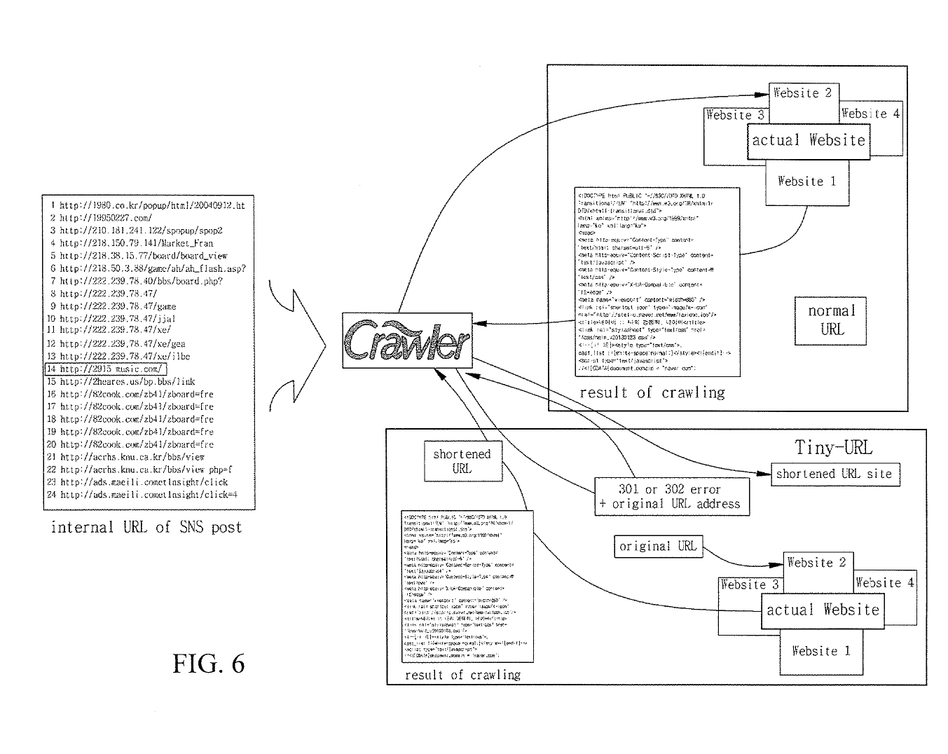

Extraction of URL information through crawling is specifically illustrated in FIG. 6. This will be described later. Finally, in step S170, the new search word list collected in step S130 and the URL information collected in step S160 are registered.

Meanwhile, the method for collecting a URL (S100) using a retrieval service of an SNS according to an embodiment of the present invention may further include determining whether or not a certain search word on the new search word list received in step S130 and a previously stored search word are identical and removing a repeated search word when the search words are identical, between steps S130 and S140. By removing the repeated search word, URL information may be more easily retrieved from the SNS site 310 with the real-time search word information in an optimal state.

Similarly, the method for collecting a URL (S100) using a retrieval service of an SNS according to an embodiment of the present invention may further include determining whether or not URL information collected in step S160 and previously stored URL information are identical and removing repeated URL information when the collected URL information and the stored URL information are identical, between steps S160 and S170.

By removing the repeated URL information, the URL information in an optimal state may be utilized to check an SNS URL suspicious to be malicious, and also, utilized to collect various malicious codes generated in the SNS.

Also, the method for collecting a URL (S100) using a retrieval service of an SNS according to an embodiment of the present invention may further include accessing an original site which has generated the shortened URL and obtaining original URL information from an original site, when the collected URL information is determined to be a shortened URL. This process will be described in detail with reference to FIG. 6.

### Example of Processing Shortened URL

FIG. 6 is a diagram illustrating a process of processing a shortened URL according to the second embodiment of the present invention. Referring to FIG. 6, in the process of processing the shortened URL according to the second embodiment of the present invention, when it is determined that URL information of ‘Crawler’ among URL information included in the bulletin script is a shortened URL, original URL information is obtained from the shortened URL site through the shortened URL information.

Subsequently, an actual website is visited and when it is determined that the URL is a normal URL, crawling result may be obtained, but when it is determined that URL information of ‘Crawler’ among the URL information included in the bulletin script is shortened URL information, a shortened URL site is visited with the shortened URL information, and when it is determined to be different information, the original URL information is obtained from the shortened URL site.

Thereafter, the actual website may be visited with the original URL information to obtain normal original URL information, and it is crawled to generate an XML document form. In this manner, although shortened URL information is included in post, the original URL information is obtained and utilized for collecting and checking a malicious code, or the like.

As set forth above, according to embodiments of the invention, URL information for a malicious code included in post (a bulletin script, a message, a note, or the like) exchanged in an SNS based on real-time search word information can be effectively collected and utilized for detecting a malicious code in the SNS, whereby damage to users due to infection of a malicious code can be significantly reduced.

Also, according to embodiments of the invention, although post (a bulletin script, a message, a note, or the like) in the SNS includes shortened URL information, each information can be collected through crawling and restoration and utilized for detecting a malicious code, whereby damage to users due to infection of a malicious code can be further reduced.

In addition, by recording history information in relation to real-time search word information, although a myriad of URL information and shortened URL information are obtained, they can be repeatedly removed and a security management can be secured.

Further, since URL information of a real-time search word and post is obtained by using an open API provided from a search site or an SNS site, the open API can also be used for the purpose of removing a malicious code, beyond the existing limitation of program development.

While the present invention has been shown and described in connection with the embodiments, it will be apparent to those skilled in the art that modifications and variations can be made without departing from the spirit and scope of the invention as defined by the appended claims.

What is claimed is:

1. A system for collecting a uniform resource locator (URL) using a retrieval service of a social networking service (SNS), the system comprising:
a search word collecting module configured to periodically collect ranked real-time search word information provided through a search site;
a URL collecting module configured to extract and collect URL information of post exchanged in an SNS site based on the real-time search word information; and
a registration management module configured to check whether or not the collected real-time search word information and the collected URL information are repeated within a pre-set time, and register the real-time search word information and the URL information when they are not repeated.

2. The system of claim 1, further comprising:
a history information collecting module configured to collect history information in relation to the real-time search word information and URL information, the history information including details of an initial collecting time, a search word collecting path, the number of repeated collecting, and a repeated collecting time.

3. The system of claim 1, wherein the search word collecting module and the URL collecting module collect the real-time search word information and the URL information by using an open API provided from the search site and the SNS site, respectively.

4. The system of claim 3, wherein the URL collecting module extracts the URL information by crawling a post URL of the post.

5. The system of claim 1, further comprising:
an original URL collecting module configured to access an original site which has generated a shortened URL and obtain original URL information from an original site, when the URL information is a shortened URL.

6. A method for collecting a uniform resource locator (URL) using a retrieval service of a social networking service (SNS), the method comprising:
(a) executing an interworking process between a URL collecting system and a search site;
(b) determining whether or not there is a new search word list as a real-time ranking provided from the search site, after (a) is executed;
(c) when it is determined that there is a new search word list, receiving the new search word list from the search site;
(d) executing an interworking process between the URL collecting system and an SNS site;
(e) determining whether or not certain real-time search word information on the received new search word list is included in post in the SNS site, after (d) is executed;
(f) when it is determined that the real-time search word information is included in the post, extracting and collecting URL information from the post; and
(g) registering the collected new search word list and URL information.

7. The method of claim 6, further comprising:
(h) determining whether or not a certain search word on the received new search word list and a previously stored search word are identical, and removing a repeated word when the certain search word and the stored search word are identical, between (c) and (d).

8. The method of claim 6, further comprising:
(i) determining whether or not the collected URL information and the previously stored URL information are identical and removing repeated URL information when the collected URL information and the stored URL information are identical, between (f) and (g).

9. The method of claim 6, wherein, in (a) and (d), the search site and the SNS site are accessed by using an open API.

10. The method of claim 6, wherein, in (f), the URL information is extracted by crawling the post URL of the post.

11. The method of claim 6, further comprising:
(j) accessing an original site which has generated the shortened URL and obtaining original URL information from an original site, when the URL information is a shortened URL.
